(19) United States
(12) Patent Application Publication
(10) Pub. No.: US 2009/0229425 A1
(43) Pub. Date: Sep. 17, 2009

(54) One touch retractable ratchet wrench

(76) Inventors: Richard Riggio, Philadelphia, PA (US); John D'Annunzio, Kennett Square, PA (US)

Correspondence Address: CARDINAL LAW GROUP, LLC, SUITE 2000, 1603 ORRINGTON AVENUE, EVANSTON, IL, 60201, US

(21) Appl. No.: 12/319,274

(22) Filed: Jan. 5, 2009

Related U.S. Application Data
(60) Provisional application No. 61/006,260, filed on Jan. 3, 2008.

(51) Int. Cl. B25B 13/46

(52) U.S. Cl. 81/63

(57) ABSTRACT

A one touch retractable ratchet wrench for use when side access to a workpiece is necessary. The ratchet wrench comprises an opening at one end for side application of a socket to a workpiece. The ratchet further comprises a retracting spring attached to a pawl containing the socket. A release control releases any restraint on the retracting spring, returning the pawl to a home position in which side access to and removal from a workpiece can be made.

### FIELD OF THE INVENTION

This application claims priority from provisional application Ser. No. 61/006,260 filed Jan. 3, 2008.

The present invention relates to the field of general and special-purpose tools for use by both professional mechanics and do-it-yourself hobbyists. In particular, the invention relates to a solution for hard to access mechanical elements that need to be torqued for installation and removal whereby the ratchet must be joined to the workpiece from the side rather than above or below.

### BACKGROUND OF THE INVENTION

Both professional laborers in plumbing and construction trades and non-professional handymen encounter numerous tasks in which a workpiece requires the application of rotational torque for tightening or loosening. In most cases, the workpiece is accessible from above or below and the tool of choice is a common ratchet wrench. However, there are occasions on which the workpiece (a fitting or a bolt) may only be accessible from the side, such as a fitting on a pipe. This circumstance commonly requires a crescent wrench or a spanner, which are often large and unwieldy in tight quarters. A tool that is more compact and versatile would be of great benefit to workers facing the need to apply torque from the side of a workpiece.

### SUMMARY OF THE INVENTION

The present invention is a retractable ratchet wrench which can be used as a specialty ratchet wrench as well as a conventional ratchet wrench. It has multiple sockets in both metric and inch measure. The wrench has an opening at the top that allows the socket of choice to be inserted for use. It also has an opening in the operating end that lines up with the opening at the top of the wrench, giving the wrench and socket the ability to slide over a pipe or other object (“workpiece”) for access to a fitting or bolt so that the fitting or bolt can be tightened or loosened in a ratcheting fashion. Once this is accomplished the wrench and socket can be backed off the fitting or bolt and removed from the workpiece with the depression of a one-touch retracting release on the side of the wrench. This socket retracts quickly to align the opening at the end of the wrench for easy removal from the workpiece. The wrench also has a separate housing area built into the handle allowing the attachment of a torque wrench, giving the wrench of the invention the capability to torque a fitting or bolt to a precise measure of foot-pounds.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a perspective drawing of the wrench of the invention from above and below.

FIG. 2 is a top view assembly drawing of the wrench body, the operational works of the wrench, and the top plate.

FIG. 3 is a perspective view of both sides of the operational works of the wrench.

FIG. 4 is a section view of the operational works of the wrench.

FIG. 5 is an exploded view of the operational works of the wrench.

FIG. 6 illustrates several plan views of an example ratchet that may be used with the wrench of the invention.

### DETAILED DESCRIPTION OF THE INVENTION

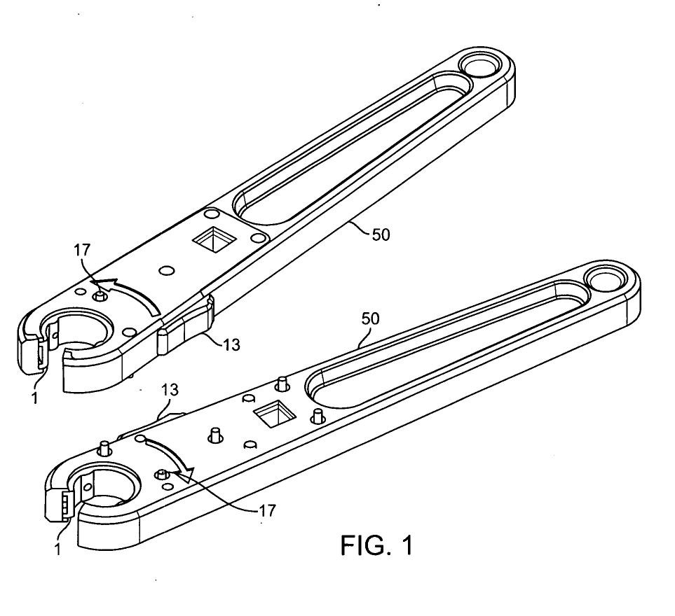

Referring to the drawings, wherein like reference numerals illustrate corresponding or similar elements throughout the several views, the basic features of the ratchet wrench of the invention are illustrated in FIG. 1. The body 50 of the ratchet has an opening at one end. The opening is lined with a pawl 1 with teeth (see later Figures) on it interior edge. Any one of a number of sized. sockets (see FIG. 7 example) can be inserted into the center opening of the pawl 1. The open end of the wrench permits the ratchet to access a fitting or bolt from the side as well as above so that the ratchet is capable of use in more restricted access locations than a standard ratchet. If the bolt or fitting is on a pipe or tubular structure, for instance, the ratchet can be placed onto the bolt from the side and turned in the desired direction.

A one touch release 17 triggers the release of a spring mechanism inside the wrench to return the socket to a home position such that the end of the wrench is again open with the opening in the socket aligned with the opening in the end of the wrench. Once that realignment occurs the wrench can be removed from the workpiece. A slide 13 allows the operator to easily change the direction of use from clockwise to counterclockwise without disengaging the tool from the workpiece.

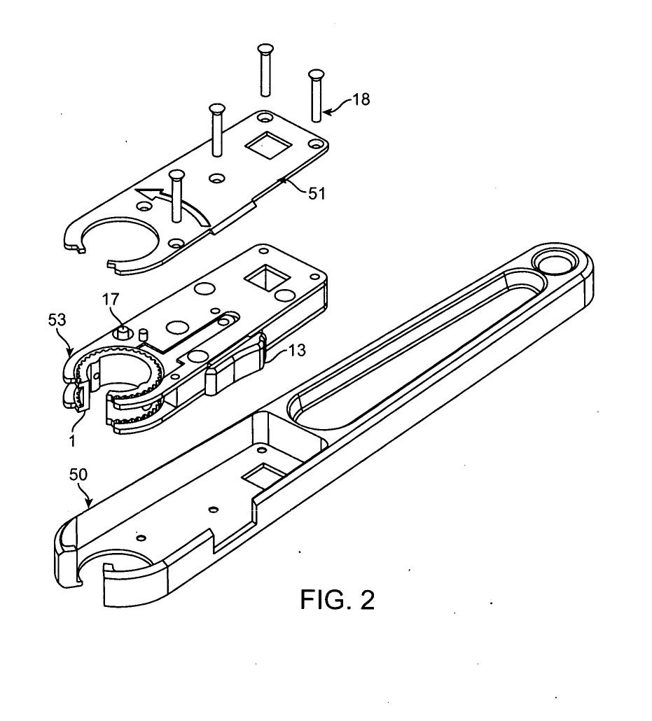

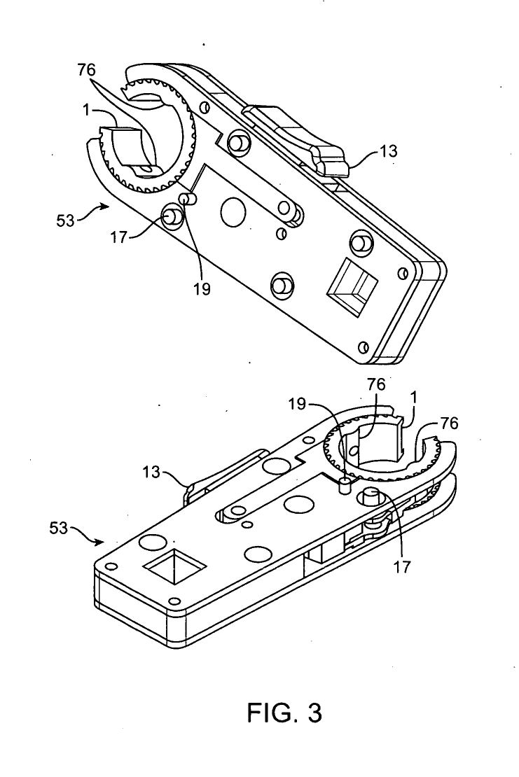

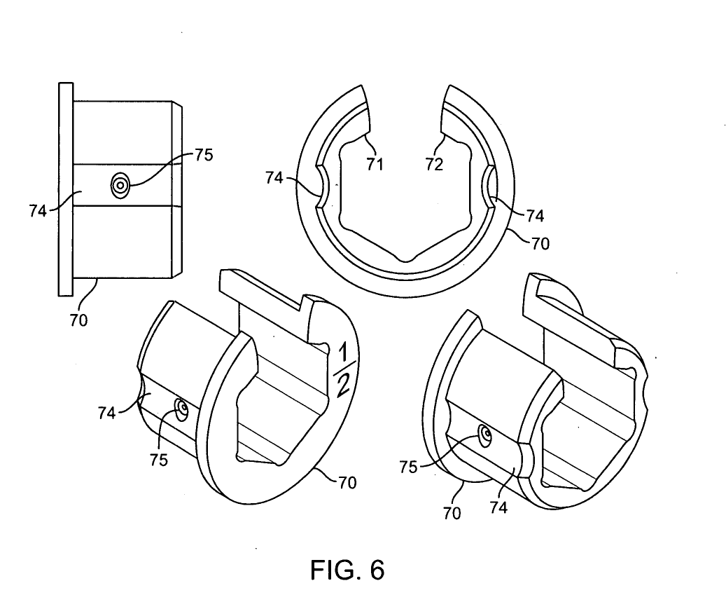

FIG. 2 shows the body 50 of the wrench with the operational works 53 section removed from the body. A cover plate 51 for the operational section is displayed separately and illustrates the rivets 18 that hold the assembly together. FIG. 3 is a closer illustration of the operational works of the ratchet. The pawl 1 is shown without a socket installed. The two protrusions 76 on the inside surface of the pawl 1 provide the guides for installation of a socket (see FIG. 6) having two matching slots on the socket body.

In operation, the ratchet engages a workpiece with the proper sized socket installed in the ratchet. Using the slide control 13, the operator can select clockwise or counterclockwise operation for tightening or loosening the workpiece. As the ratchet is repetitively turned, the pawl/socket section rotates within the tool which can result in closing the open end of the wrench around the workpiece. When the operator wishes to remove the wrench, the socket is moved up or down to disengage from the fitting or nut being worked, then the one touch release 17 is pressed to return the pawl/socket assembly to its home position, opening the operating end of the wrench. The wrench is then removed from the workpiece completely.

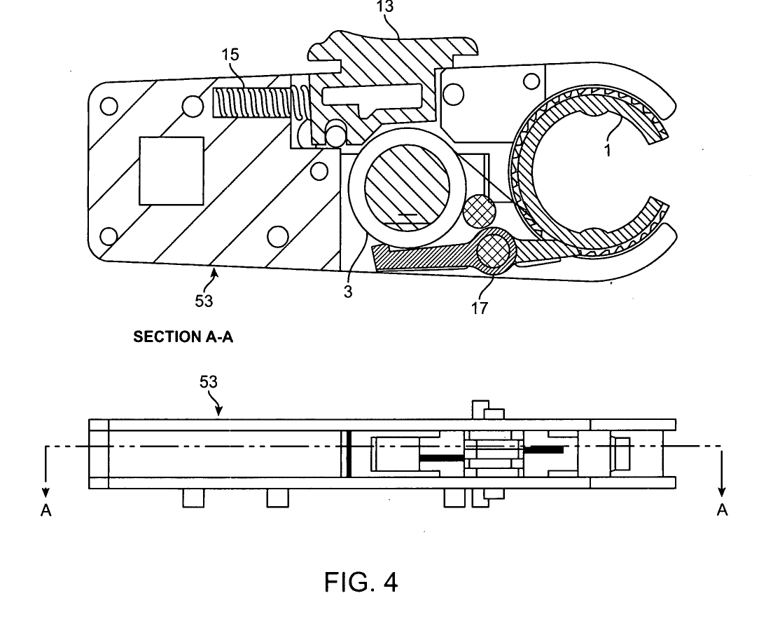

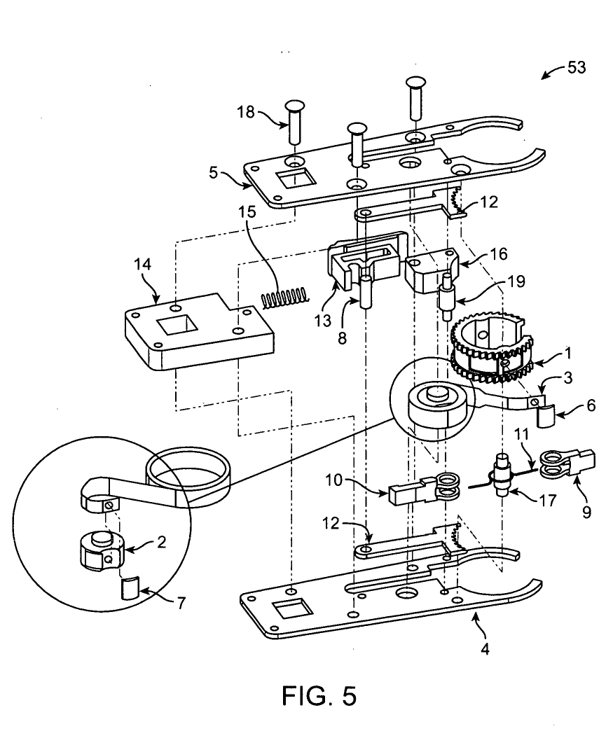

FIG. 4 illustrates the internal features of the operational works of the wrench. A coil spring 15 attaches to the direction control slide 13 providing the force to urge it into its normal position, from which a touch of the thumb moves the slide into the reverse ratchet operating position. At the ratchet end ,a retracting spring 3 (see also FIG. 5) is attached to the pawl 1 within the wrench. As the pawl rotates, the spring 3 plays out its metal strip. At the end of each turn of the pawl, the teeth on the pawl lock it and prevent its reverse motion, as in most ratchets. This keeps the retracting spring 3 under tension until the work is done. When the one touch release 17 is pressed, the teeth on the pawl are disengaged and the pawl quickly retracts to its home position under tension from the spring, opening the operational end of the wrench.

FIG. 5 illustrates the assembly of the ratchet operational works 53. In particular, the assembly shows the connection of the ratchet retracting spring 3 to the pawl 1 held in place by a clip 6. At the center of the retracting spring 3 is an anchor post 2 to which the inside end of the retracting spring is attached by another clip 7. The teeth on the pawl 1 engage the opposing teeth on one or the other of rotation locks 12 in operation depending on the selection of clockwise or counterclockwise rotation. Pressing the one touch release 17 disengages the teeth on the rotation locks from the teeth on the pawl 1. This leaves the pawl 1 free to snap back to its home position under the influence of the retracting spring 3.

FIG. 6 shows views of an example socket 70 for use in the ratchet wrench in several aspects. The socket 70 has a hexagonal interior shape in which two faces 71, 72 of the hexagon are truncated so that one end of the socket remains open. The external cylinder of the socket has two matching grooves 74 with locking depressions 75 centered in them. The socket is inserted into the center of the pawl 1 of the ratchet by aligning the grooves 74 with the protrusions 76 on the inside cylindrical surface of the pawl 1. Sockets of varied sizes for engaging workpieces may be used in the ratchet wrench of the invention, including both inch and metric measure.

Other variations of the apparatus can be conceived that provide the beneficial results of the invention while not deviating from the basic design features described herein. Reference to the following claims determines the appropriate scope of the present invention.

What is claimed is:

1. A retractable ratchet wrench comprising:
an elongated body having an opening at one end;
a rachet operating assembly within said elongated body comprising a generally cylindrical pawl for receiving a socket, said pawl having an opening in one segment substantially conforming to the opening in the elongated wrench body when said pawl is in its home position, said pawl further comprising one or more sets of teeth around its circumference for engaging a ratchet locking mechanism;
a retracting spring attached to said pawl;
a release control for releasing said ratchet locking mechanism such that said pawl returns to the home position when disengagement from a workpiece is desired.
